(19) United States
(12) Patent Application Publication
(10) Pub. No.: US 2010/0284168 A1
(43) Pub. Date: Nov. 11, 2010

(54) ILLUMINATION DEVICES WITH VOLATILE ACTIVE EMISSIONS

(76) Inventors: Scott D. Walter, Twin Lakes, WI (US); Simon M. Conway, Burlington, WI (US); Kevin Harrity, Oak Creek, WI (US); Deborah Holmes Parker, Racine, WI (US); David D. Carlson, Cedarburg, WI (US); Mark E. Johnson, Mount Prospect, IL (US)

Correspondence Address: S.C. JOHNSON & SON, INC., 1525 HOWE STREET, RACINE, WI, 53403-2236, US

(21) Appl. No.: 12/734,274

(22) PCT Filed: Oct. 29, 2008
(86) PCT No.: PCT/US2008/081588

§ 371 Date: Jul. 7, 2010

Related U.S. Application Data
(60) Provisional application No. 60/983,392, filed on Oct. 29, 2007.

(51) Int. Cl. F21V 33/00

(52) U.S. Cl. 362/96; 362/231; 362/253

(57) ABSTRACT

An illumination and volatile active dispenser device and corresponding control circuits are disclosed. The device supports at least one white light source to emit illumination light, and a plurality of colored LEDs capable of providing a sequence of light patterns and ambient light. The modular control unit provides a volatile active dispenser to control volatile active emission rates. Thus, the illumination and volatile active dispenser device provides illumination light, ambient light, light shows, volatile active emission control, and combinations thereof, within a single standalone but modular device.

### CROSS-REFERENCE TO RELATED APPLICATION

This application is an international application which is based on and claims priority under PCT Rule 4.10(a) from provisional Application Ser. No. 60/983,392, filed on Oct. 29, 2007 in the United States of America.

### FIELD OF THE DISCLOSURE

The present disclosure generally relates to air treatment and, more particularly relates to an air treatment device which provides not only a vehicle for delivering a volatile active such as a fragrance or insect repellant, but also provides the utility of a white light source, and the aesthetic enhancement of colored light emitting diodes in a single fixture.

### BACKGROUND OF THE DISCLOSURE

Creating a pleasant ambiance is a popular aspect of home decor. This is often achieved through various combinations of pleasant fragrances with mood lighting. Lighting can also be combined with other functions such as air sanitization, air deodorization, and the controlled release of insect repellent, insect attractant and insecticide. Conventional products such as scented candles, mood lighting devices, fragrance dispensers, and the like, are commonly used to create a pleasant environment in the home. While those conventional products help to create a pleasant living environment and ambiance, they have their drawbacks.

For example, while scented candles create soft light and fragrance, which creates a pleasant mood, candles are a potential fire hazard and often produce unwanted smoke and wax drippings. Traditional light fixtures and lamps do not provide the color effects, fragrance emission or other volatile active emissions that users often desire. While stand-alone aesthetic devices are available for providing lighting effects (such as color changing and the like), these stand-alone devices do not provide volatile active emissions and take up additional space around the home, adding to the clutter that many consumers are trying to avoid. Additionally, light fixtures and stand-alone devices have external switches, power cords, and the like, which make the devices themselves unattractive.

Furthermore, traditional light fixtures, lamps and stand-alone devices require a DC power supply, an AC power supply, or a combination of both. More specifically, a device requiring a DC power supply uses batteries and a device requiring an AC power supply uses a power cord. A device that uses batteries eliminates the need for unsightly power cords and does not take up additional outlets. However, batteries provide limited power and need to be replaced periodically, resulting in additional costs to the consumer. Alternatively, a device that uses a power cord minimizes additional expenses to the consumer. However, the power cord adds clutter to the home and takes up additional outlets.

A device that provides a combination of both DC and AC power supplies, or a dual power supply, gives the consumer the option of selecting between the two sources. In general, such devices include a compartment for batteries and an input jack for an adapter plug. When using the DC power supply, batteries are supplied to the device and the input jack is left unplugged. When using the AC power supply, the batteries are removed and an adapter is connected between the input jack and a wall outlet. While dual power supplies offer the benefits of both power options to the consumer, such devices are generally sold without the adapter. In order to take full advantage of the dual power supply without the added costs, the consumer is forced to locate an unused adapter around the house. However, it is usually more difficult to find an adapter matching the exact size and voltage rating as required by the input jack.

Conventional fragrance dispensers, such as plug-in diffusers, can provide pleasing aromas in a relatively inexpensive, compact package. However, such conventional fragrance dispensers generally take up outlets and are often located out of sight, causing a user to forget to adjust or refill the device. While these fragrance dispensers may also provide light, because the devices are used in existing electrical outlets, they are generally positioned too low to provide effective lighting features, other than to operate as a nightlight.

Conventional nightlights include only white light emission in combination with fragrance emission. While a single scent may be provided in the form of a decorative diffuser, colored nightlights are not generally available and there is no coordination between the light color emitted and the particular fragrance emitted. Further, sophisticated multi-colored lights that change color and that are aesthetically pleasing in combination with fragrance emission are not currently available.

Further, numerous needs exist for devices providing the combination of white light and colored light with volatile active emissions other than fragrances, such as air sanitization, air deodorization, the controlled release of insect repellent, insect attractant, insecticide, aromatherapy volatiles or other non-fragrant materials (any of which may be combined with fragrant materials if necessary to make the ambient environment more tolerable). More importantly, numerous needs exist for compact modular circuits enabling the combinations of colored light and volatile active emissions. Modular circuits allow for the interchangeability of parts and features while also promoting expandability.

Recent developments in lighting have led to advancement in light emitting diodes (LEDs) and supporting drive circuits. An LED is a semiconductor device that emits visible light when an electrical current passes through it. The light from an LED is basically monochromatic and the color of the light is determined by the particular material used in the semiconductor (although current applied to the LED can be used to vary the perceived color). LEDs have the advantage of low power requirements, high efficiency and long life. The outputs of several different colored LEDs can be mixed so as to produce additional colors, white light, and different intensities. LEDs can also be used to provide background lighting to achieve desired ambient effects. Until now, LEDs and supporting circuitry have been generally used for such applications as indicator lights, panel backlighting and fiber optic data transmission.

LED lamps having multicolor adjustors with supporting circuitry or the like exist. These devices typically comprise a base in which several LEDs capable of producing different colored light are mounted upon a circuit board. The circuit provides adjustable and external switches for the different colored LEDs so that the colors can be mixed in any desired ratio to produce desired lighting effects such as varying colors and intensity.

Devices also exist for providing ambient light from a free-standing lamp using LEDs. In one such device, ambient light in the form of a simulated candle is provided by a microprocessor and supporting circuitry emitting both color combinations and flicker effects. These devices are directed toward lamps with external switches for achieving soothing ambient effects. There are also other devices for controlling the light output of several LEDs according to user input and the predetermined program installed. The user input is provided by external switches disposed on a housing. However, there is no device having aesthetically pleasing and discrete switches that allow user control of illumination light, ambient light and volatile active emissions within a single fixture.

Therefore, multiple needs exist for devices with supporting circuitry that provide discrete switches and the combination of one or more of the following functions: white light emission; colored light emission; fragrance emission; air sanitization; air deodorization; insecticide emission; insect repellent emission; aromatherapy material emission; light emission that repels insects; light emission that attracts insects; and any combinations thereof. Furthermore, needs exist for the modular design of the circuitry. Additional needs exist for controllers and related circuitry that provide dual power supplies having an input jack capable of receiving a wide range of adapters, in terms of both plug sizes and voltage ratings.

### SUMMARY OF THE DISCLOSURE

In accordance with one aspect of the disclosure, an illumination source and volatile active emission dispenser is provided which comprises a base comprising a modular control unit and a switch disposed on an interior of the base, the modular control unit comprising a driver circuit, a microprocessor, at least one white light source, a plurality of colored light emitting diodes (LEDs), and a volatile active dispenser; a translucent element coupled to the base and configured to transmit light from at least one of the white light source and the colored LEDs; and a volatile active cartridge disposed at least partially within the translucent element.

In accordance with another aspect of the disclosure, an illumination source and volatile active emission dispenser without external switches is provided which comprises a base comprising a modular control unit and a switch disposed on an interior of the base, the modular control unit comprising a driver circuit, a microprocessor, at least one white light source, a plurality of colored LEDs, and a fan; a battery compartment on a bottom surface of the base; a translucent element coupled to the base configured to transmit light from at least one of the white light source and the colored LEDs; and a volatile active cartridge disposed at least partially within the translucent element.

In accordance with another aspect of the disclosure, an illumination source and volatile active emission dispenser is provided which comprises a base comprising a modular control unit and a switch disposed on an interior of the base, the modular control unit comprising a driver circuit, a microprocessor, at least one white light source, a plurality of colored LEDs, and a volatile active dispenser, the white light source comprising one or more components selected from the group consisting of a white LED; an organic light emitting diode (OLED); an ultraviolet light emitting diode (UV LED); an incandescent lamp; and a compact fluorescent lamp (CFL); a translucent element coupled to the base configured to transmit light from at least one of the white light source and the colored LEDs; and a volatile active cartridge disposed at least partially within the translucent element.

In accordance with another aspect of the disclosure, an illumination source and volatile active emission dispenser without external switches is provided which comprises a base comprising a modular control unit and a switch disposed on an interior of the base, the modular control unit comprising a driver circuit, a microprocessor, at least one white light source, a plurality of colored LEDs, and a volatile active dispenser; a translucent element coupled to the base; and a volatile active cartridge at least partially disposed within the translucent element and comprising a key to mateably engage the switch, the switch capable of activating one or more functions selected from the group consisting of activating the sequence of light patterns; turning on the white LED; turning on the colored LEDs; turning off the white LED; turning off the colored LEDs; scrolling through the light patterns; holding a selected light pattern; adjusting an intensity of the LEDs; adjusting an output rate of the volatile active dispenser; and deactivating the sequence of light patterns.

These and other aspects of this disclosure will become more readily apparent upon reading the following detailed description when taken in conjunction with the accompanying drawings.

### BRIEF DESCRIPTION OF THE DRAWINGS

FIGS. 1A-1E are various views of exemplary illumination devices with volatile active emissions;

FIGS. 2A-2B are perspective views of another exemplary illumination device with volatile active emissions;

FIGS. 3A-3B are perspective views of another exemplary illumination device with volatile active emissions;

FIGS. 4A-4B are perspective views of yet another exemplary illumination device with volatile active emissions;

FIG. 5 is an exemplary control unit constructed in accordance with the teachings of the disclosure;

FIG. 6 is another exemplary control unit constructed in accordance with the teachings of the disclosure;

FIG. 7 is a circuit schematic of an exemplary user interface module;

FIG. 8 is a circuit schematic of an exemplary driver circuit;

FIG. 9 is a circuit schematic of an exemplary LED array module;

FIG. 10 is a perspective exploded view of an exemplary CFL, a plurality of white LEDs and a satellite array of colored LEDs;

FIG. 11 is a circuit schematic of an exemplary volatile active dispenser module;

FIG. 12 is a perspective view of an exemplary hidden power jack; and

FIG. 13 is a circuit schematic of an exemplary power jack module.

While the present disclosure is susceptible to various modifications and alternative constructions, certain illustrative embodiments thereof have been shown in the drawings and will be described below in detail. It should be understood, however, that there is no intention to limit the present invention to the specific forms disclosed, but on the contrary, the intention is to cover all modifications, alternative constructions, and equivalents falling within the spirit and scope of the present invention.

### DETAILED DESCRIPTION

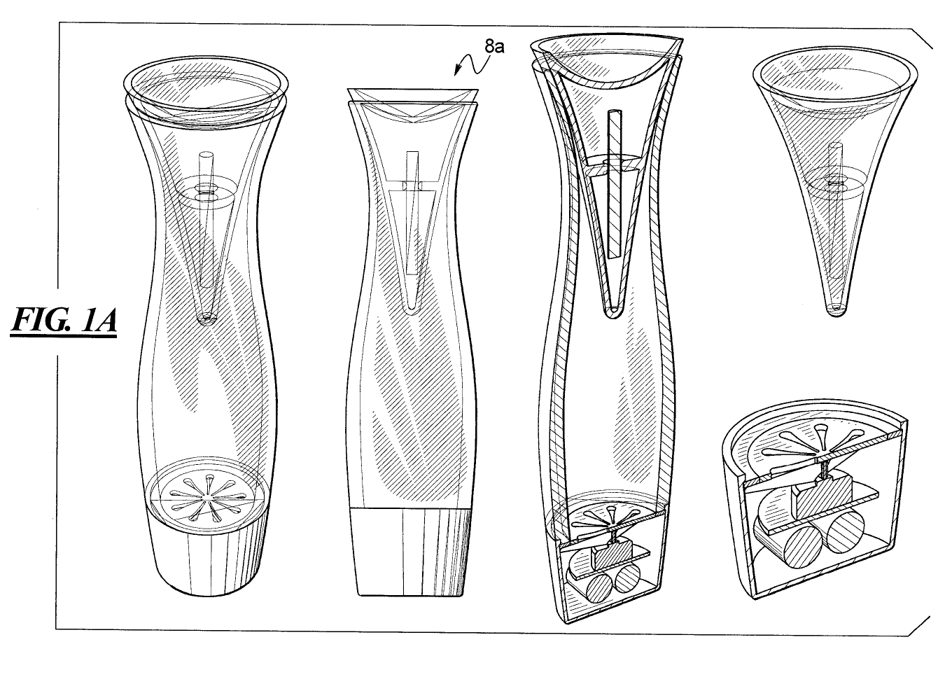

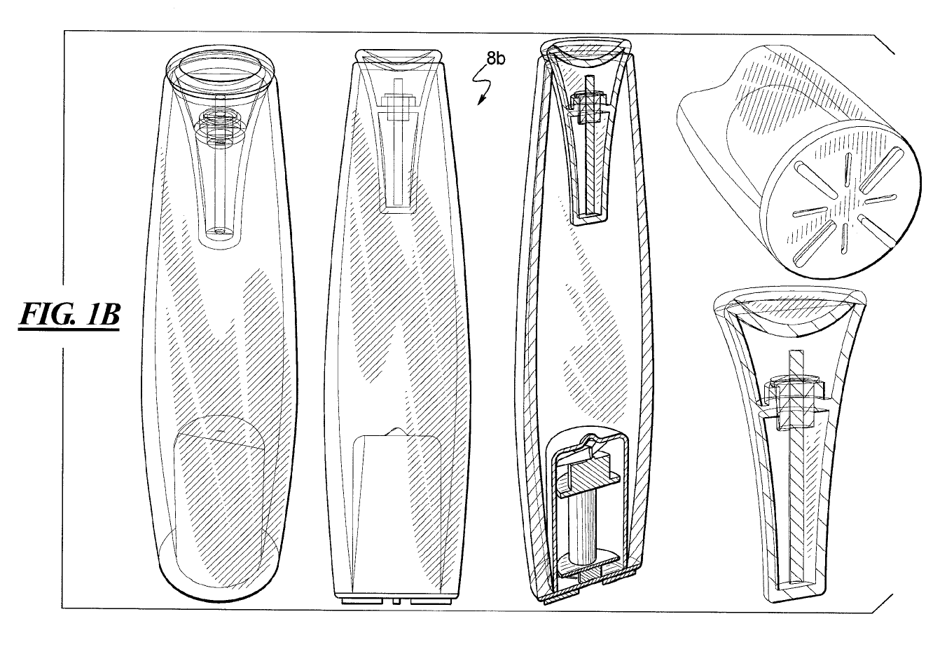

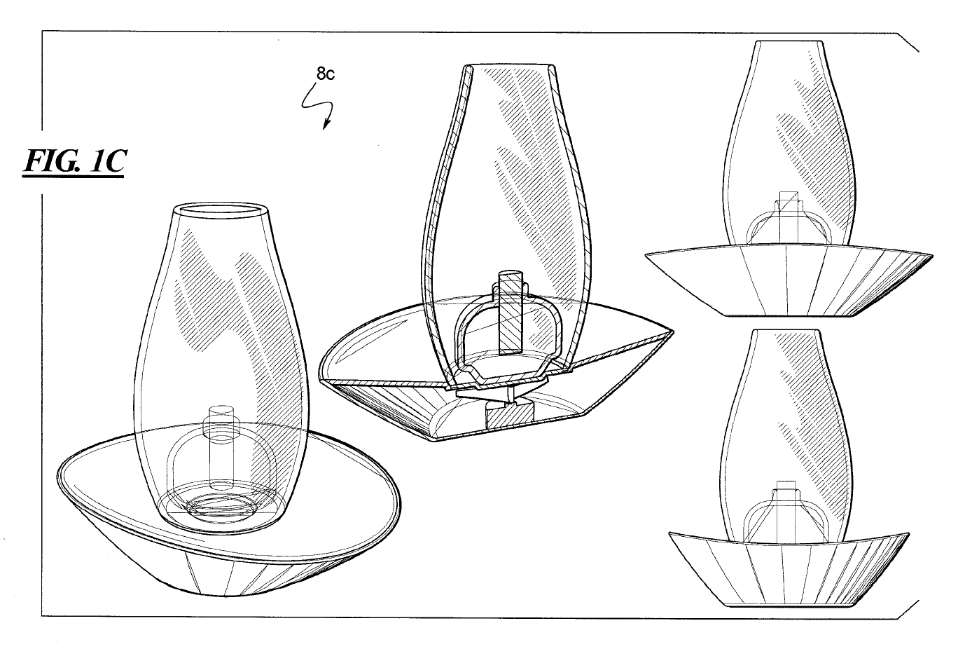

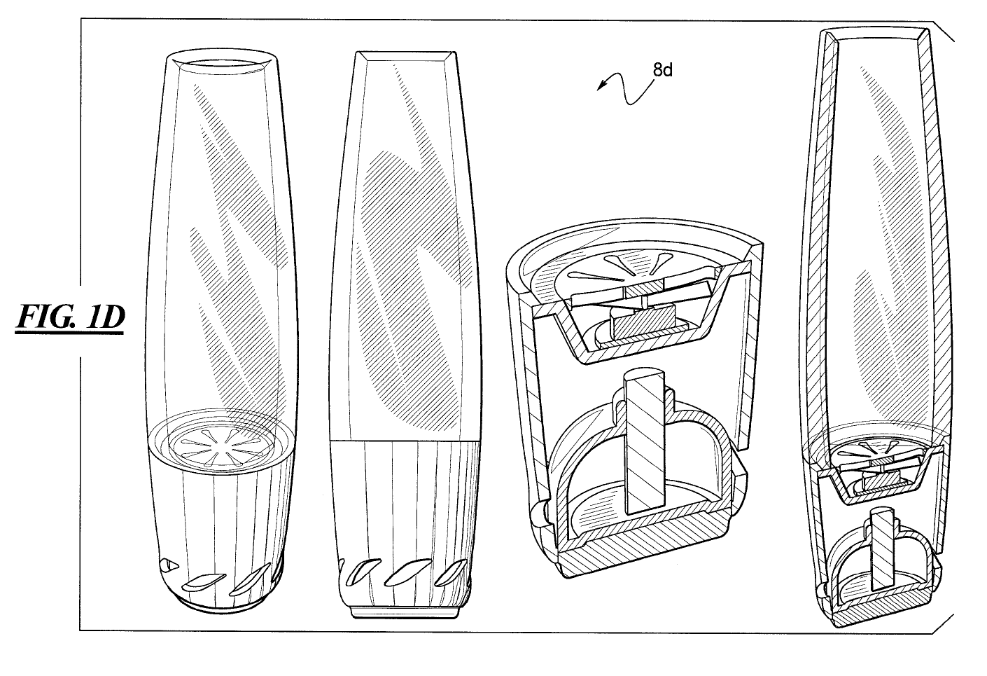

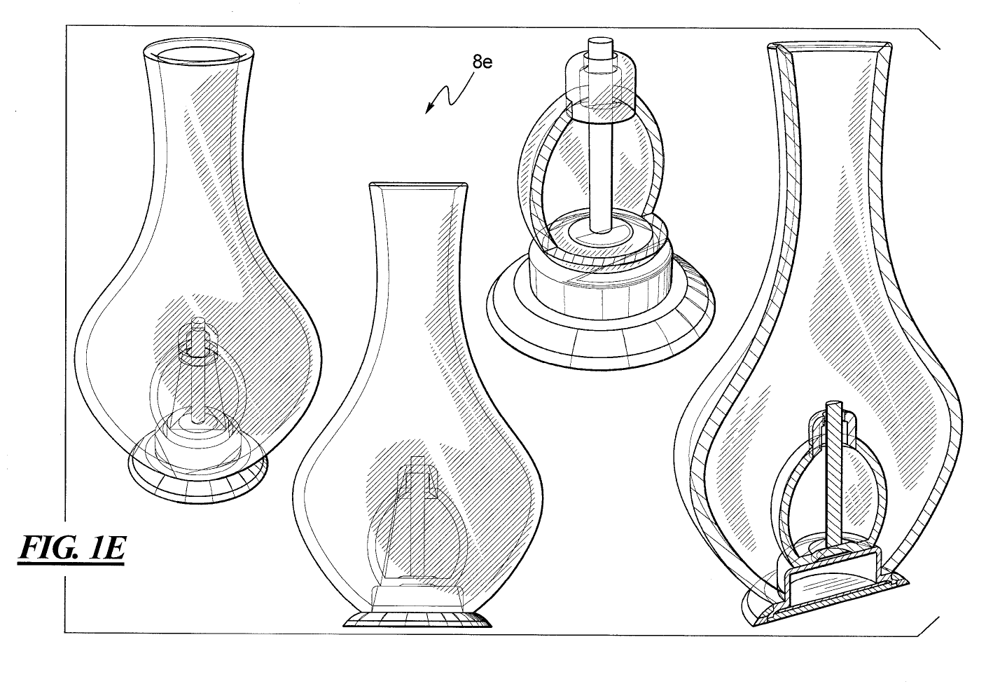

Referring now to the drawings and with particular reference to FIGS. 1-4, exemplary illumination devices having volatile active emissions are generally referred to as reference numerals 8 and 10. It is understood that the teachings of the disclosure can be used to construct illumination and active emissions devices above and beyond that specifically disclosed below. One of ordinary skill in the art will readily understand that the following are exemplary embodiments.

The embodiments 8a-e of FIGS. 1A-1E show exemplary variations of the device disclosed herein. While white illumination light and colored light sources are not disclosed in FIGS. 1A-1E, the devices include exemplary configurations of volatile actives, volatile active cartridges, volatile active dispensers and power sources.

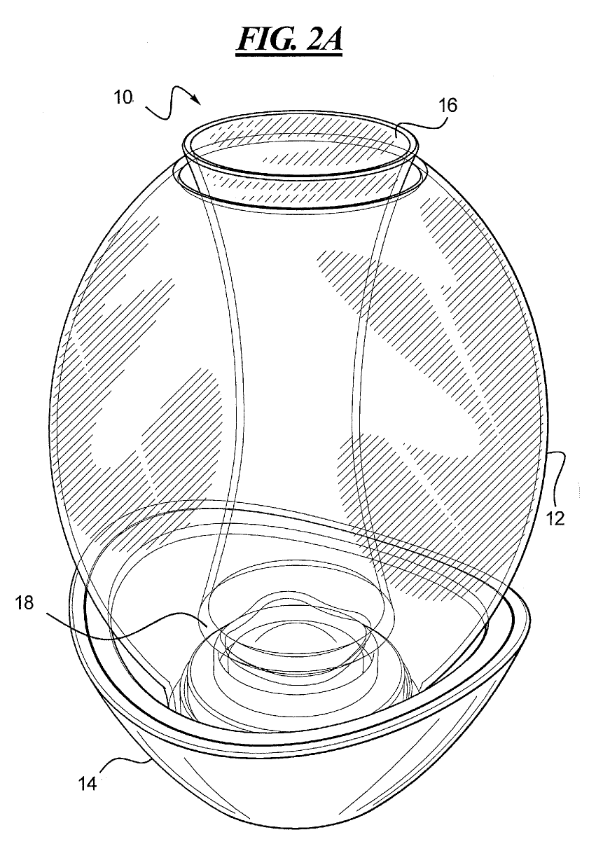

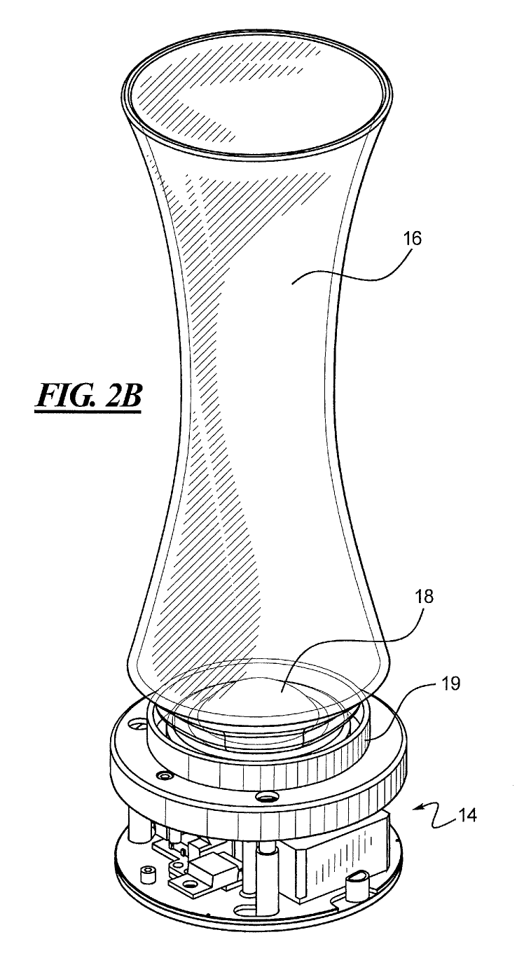

Another exemplary illumination device 10 with volatile active emissions is provided in FIGS. 2A and 2B. The illumination and active dispenser device 10 may provide a translucent element 12 that is coupled to a base 14. The translucent element 12 may serve to diffuse, transmit and/or reflect white illumination light and colored light. While shown as a globe in FIGS. 2A and 2B, any other shape including, but not limited to cubes, pyramids, cylinders, shells, flutes, shafts, amorphous forms, and the like, are possible. Moreover, the inner and/or outer surface of the element 12 may be textured to create additional lighting effects. The base 14a may provide circuitry and electronics for operating the device 10 in response to user input. A volatile active cartridge 16 may be disposed within the translucent element 12 for emitting a volatile active. To enhance lighting effects, the translucent element 12, the base 14, and/or the volatile active cartridge 16 may be configured so as to diffuse, refract, transmit and/or reflect light emitted from within the device 10. Furthermore, the volatile active cartridge 16 may serve as an interface for user input so as to eliminate external switches and to provide a more aesthetically pleasing design.

In the embodiment of FIG. 2B, the volatile active cartridge 16 may be removably coupled to the base 14 via a key 18 and a corresponding switch 19. More specifically, the key 18 may be any shape or form disposed on the cartridge 16 and mateably received by the switch 19, such that rotating the cartridge 16 also rotates the associated switch 19. The key 18 is a rounded square protrusion located at the bottom of the cartridge 16, which mates with the rounded square indentation of the switch 19. Similarly, the key 18 and switch 19 may incorporate a rectangle, a triangle, an oval, or any other shape that allows the key 18 to rotate the switch 19 when in contact with the switch 19. Furthermore, the key 18 to switch 19 fitment of FIG. 2B is shown to be a male to female fitment. However, female to male, hybrid, combination, or other key 18 to switch 19 fitments may be used. The key 18 and switch 19 of FIG. 2B may also be configured such that the cartridge 16 may be pressed or pushed down toward the base 14 to enter user input. Alternatively, the device 10 may include other types of switches 19 or sensors such that the device 10 responds to a cartridge 16 that may be turned, rotated, pressed, pulled, tilted, touched, or any combination thereof.

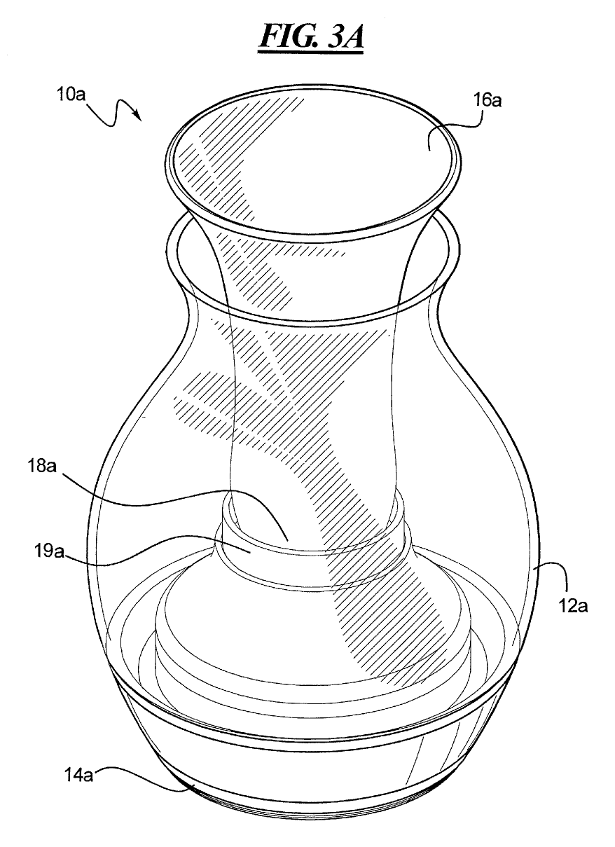

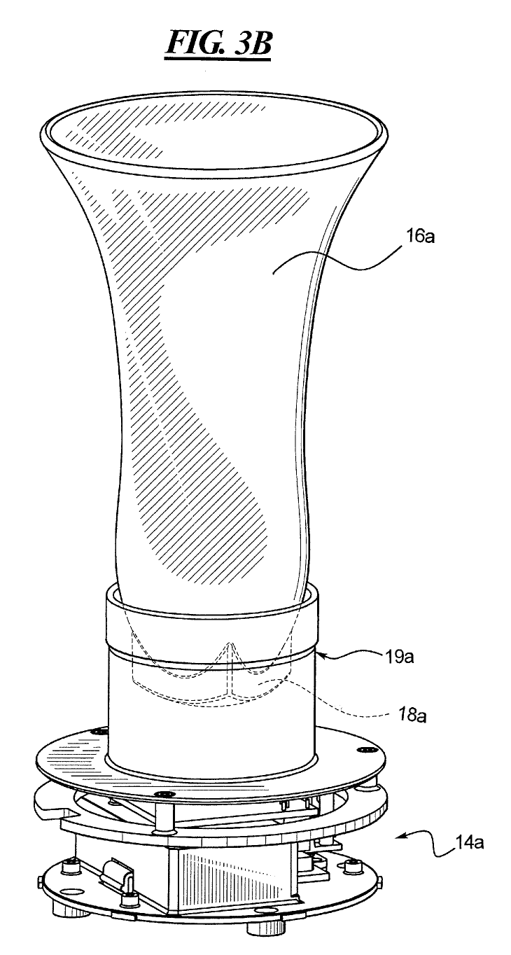

A second example of a device that may use the circuitry and electronics, as described herein, is shown in FIGS. 3A and 3B. The illumination device 10a may provide a translucent element 12a that is coupled to a base 14a. The translucent element 12a may serve to diffuse, transmit and/or reflect white illumination light and colored light. The translucent element 12a of FIGS. 3A and 3B may be any other shape including, but not limited to globes, cubes, pyramids, cylinders, shells, flutes, shafts, amorphous forms, and the like, are possible. Moreover, the inner and/or outer surface of the element 12a may be textured to create additional lighting effects. The base 14a may provide circuitry and electronics for operating the device 10a in response to user input. A volatile active cartridge 16a may be disposed within the translucent element 12a for emitting a volatile active. To enhance lighting effects, the translucent element 12a, the base 14a, and/or the volatile active cartridge 16a may be configured so as to diffuse, refract, transmit and/or reflect light emitted from within the device 10a. Furthermore, the volatile active cartridge 16a may serve as an interface for user input so as to eliminate external switches and to provide a more aesthetically pleasing design.

As shown in FIG. 3B, the volatile active cartridge 16a may be removably coupled to the base 14a via a key 18a and a corresponding switch 19a. More specifically, the key 18a may be any shape or form disposed on the cartridge 16a and mateably received by the switch 19a, such that rotating the cartridge 16a also rotates the associated switch 19a. In the embodiment of FIG. 3B for example, the key 18a is a square protrusion located at the bottom of the cartridge 16a, which mates with the square indentation of the switch 19a. Similarly, the key 18a and switch 19a may incorporate a rectangle, a triangle, an oval, or any other shape that allows the key 18a to rotate the switch 19a when in contact with the switch 19a. Furthermore, the key 18a to switch 19a fitment of FIG. 3B is shown to be a male to female fitment. However, female to male, hybrid, combination, or other key 18a to switch 19a fitments may be used. The key 18a and switch 19a of FIG. 3B may also be configured such that the cartridge 16a may be pressed or pushed down toward the base 14a to enter user input. Alternatively, the device 10a may include other types of switches 19a or sensors such that the device 10a responds to a cartridge 16a that may be turned, rotated, pressed, pulled, tilted, touched, or any combination thereof.

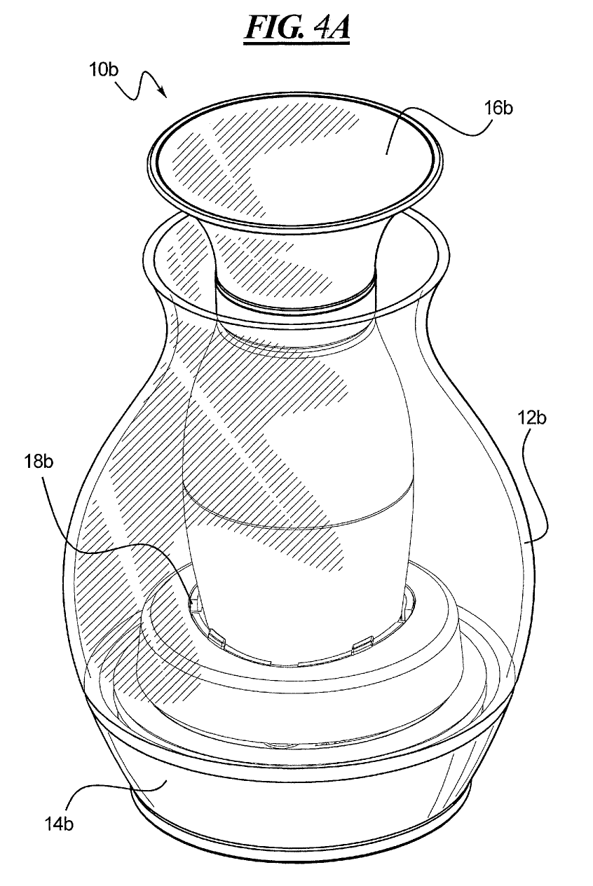

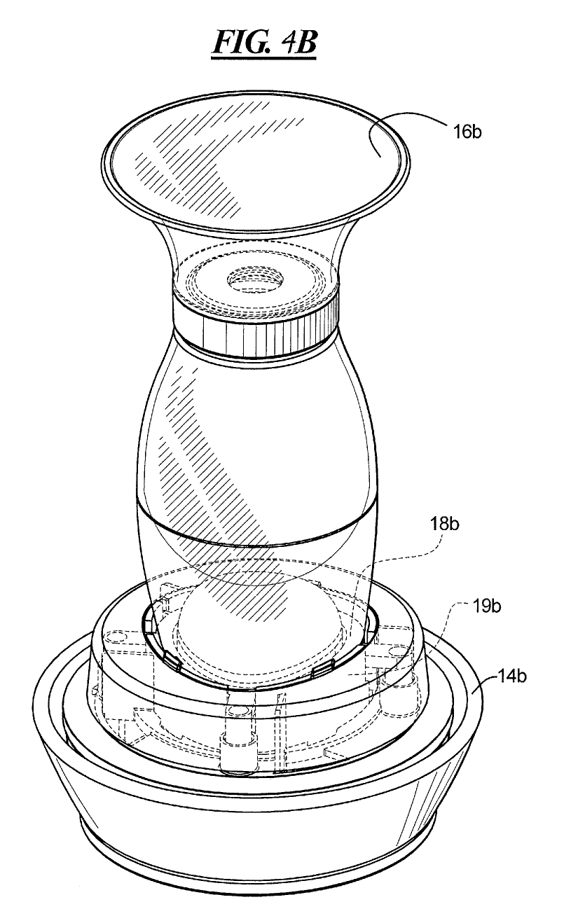

Yet another device that may use the circuitry and electronics, as described herein, is shown in FIGS. 4A and 4B. As in the previous embodiments, the illumination device 10b may provide a translucent element 12b that is coupled to a base 14b. The translucent element 12b may serve to diffuse, transmit and/or reflect white illumination light and colored light. The translucent element 12b of FIGS. 4A and 4B, any other shape including, but not limited to cubes, pyramids, cylinders, shells, flutes, shafts, amorphous forms, and the like, are possible. Additionally, the inner and/or outer surface of the element 12b may be textured to create additional lighting effects. The base 14b may provide circuitry and electronics for operating the device 10b in response to user input. A volatile active cartridge 16b may be disposed within the translucent element 12b for emitting a volatile active. To enhance lighting effects, the translucent element 12b, the base 14b, and/or the volatile active cartridge 16b may be configured so as to diffuse, refract, transmit and/or reflect light emitted from within the device 10b. Furthermore, the volatile active cartridge 16b may serve as an interface for user input so as to eliminate external switches and to provide a more aesthetically pleasing design.

Turning now to FIG. 4B, the volatile active cartridge 16b may be removably coupled to the base 14b via a key 18b and a corresponding switch 19b. More specifically, the key 18b may be any shape or form disposed on the cartridge 16b and mateably received by the switch 19b, such that rotating the cartridge 16b also rotates the associated switch 19b. In the embodiments of FIGS. 2B and 3B for example, the key 18, 18a is a square protrusion located at the bottom of the cartridge 16, 16a, which mates with the square indentation of the switch 19, 19a. However, the key 18b and switch 19b of the embodiment of FIGS. 4A and 4B is configured to be a triangular or a tri-lobed fitment. Alternatively, the key 18b and switch 19b may incorporate any other shape that allows the key 18b to rotate the switch 19b when coupled to the switch 19b. Furthermore, the key 18b to switch 19b fitment of FIG. 4B is shown to be a female to male fitment, wherein the key 18b is an indentation formed on the bottom of the cartridge 16b while the switch 19b is protruded. Other key 18b to switch 19b configurations, such as female to male fitments, hybrid or combination fitments, may also be used. The key 18b and switch 19b of FIG. 4B may also be configured such that the cartridge 16b may be pressed or pushed down toward the base 14b to enter user input. The device 10b may also include other types of switches 19b or sensors such that the device 10b responds to a cartridge 16b that may be turned, rotated, pressed, pulled, tilted, touched, or any combination thereof.

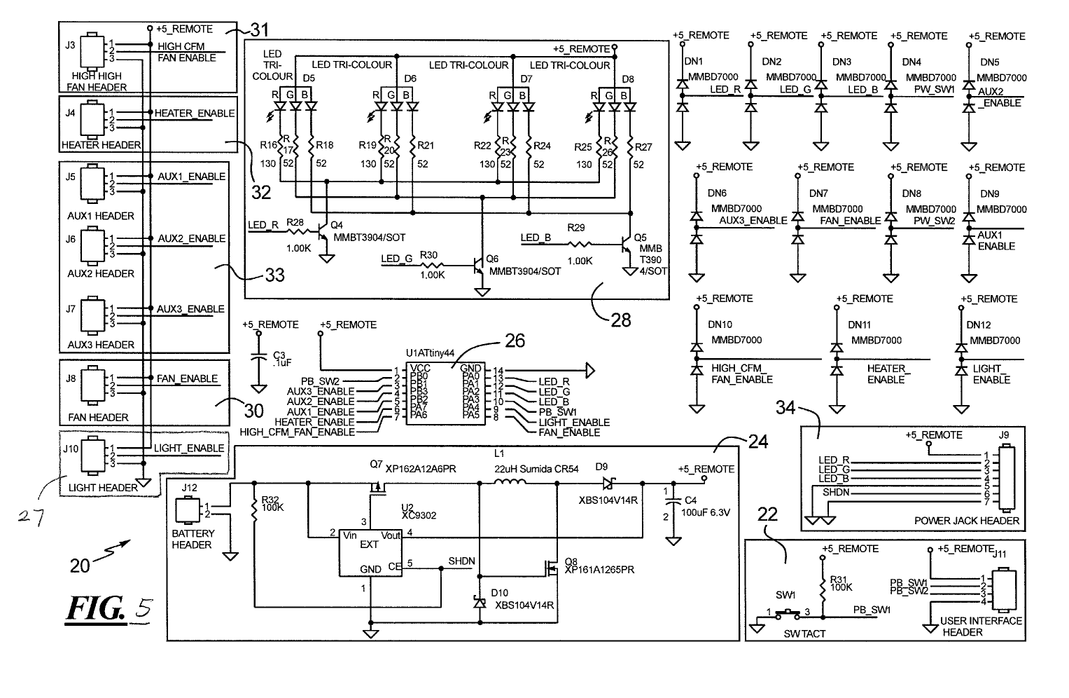

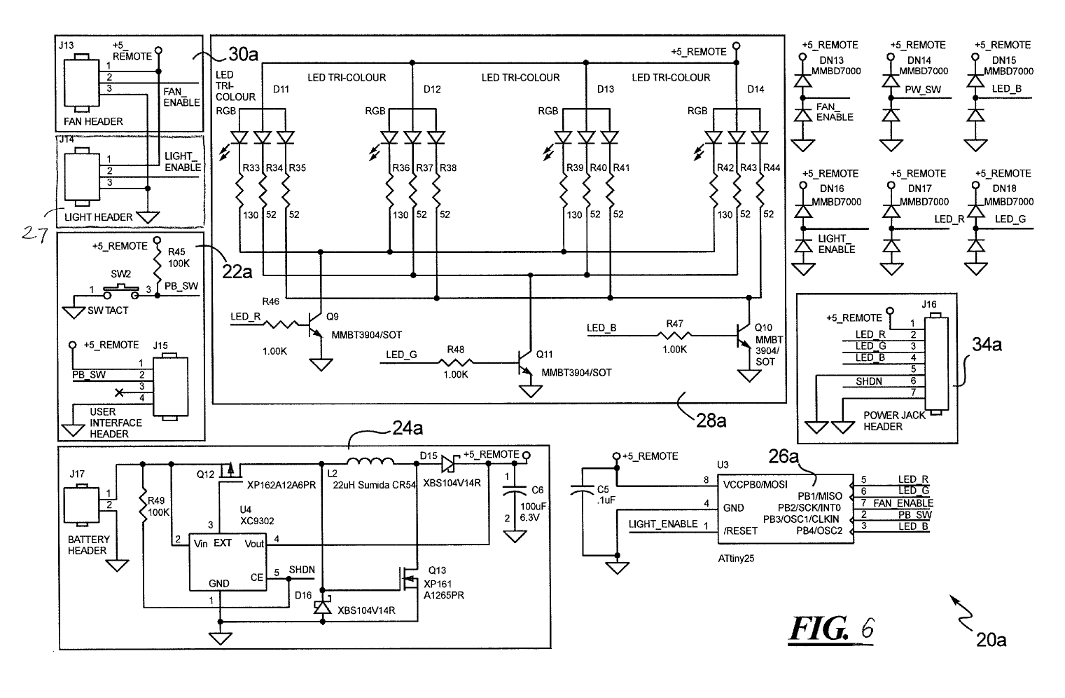

Referring now to the schematic of FIG. 5, a modular control unit 20 for driving an illumination device with active emissions is provided. The modularity of the control unit 20 provides a flexible design that may be expandable or adaptable to a number of product configurations. More specifically, the individual modules representing different features may be interchanged or removed from the control unit 20 depending on the desired application or product. The control unit 20 may also be configured to accept auxiliary modules, which while attached may override any redundant components within the control unit 20. In particular, the control unit 20 may include modules for a user interface 22, a driver circuit 24, a microprocessor 26, a white light source 27, a colored light emitting diode (LED) array 28, volatile active dispensers 30, 31, 32, auxiliary connections 33 and a power jack 34. Alternatively, smaller but upgradable controllers may be constructed for more simple applications. For example, the control unit 20a of FIG. 6 provides a user interface 22a, driver circuit 24a, a white light source 27a, a colored LED array 28a and a power jack 34a similar to those of FIG. 5, but offers a smaller microprocessor 26a and a fewer number of features. More specifically, the control unit 20a of FIG. 6 may provide only one volatile active dispenser for dispensing volatile actives, such as a low output fan 20a, while the control unit 20 of FIG. 4 provides a low output fan 30, a high output fan 31 and a heater 32. Furthermore, the control unit 20a of FIG. 6 may omit the auxiliary connections 33 found in the control unit 20 of FIG. 5.

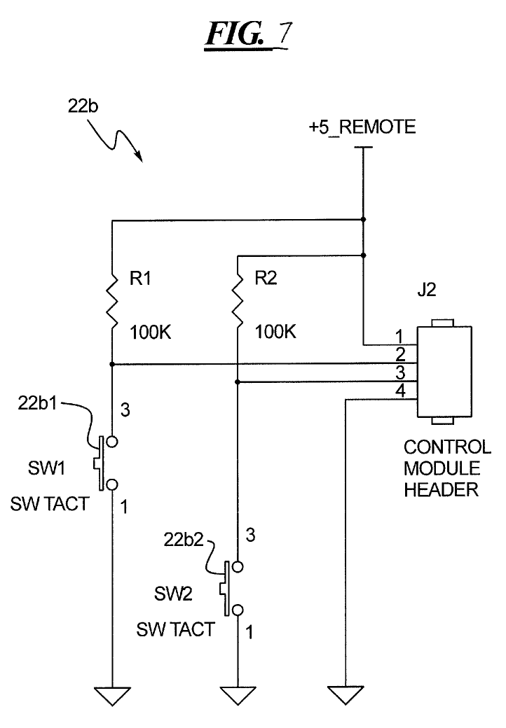

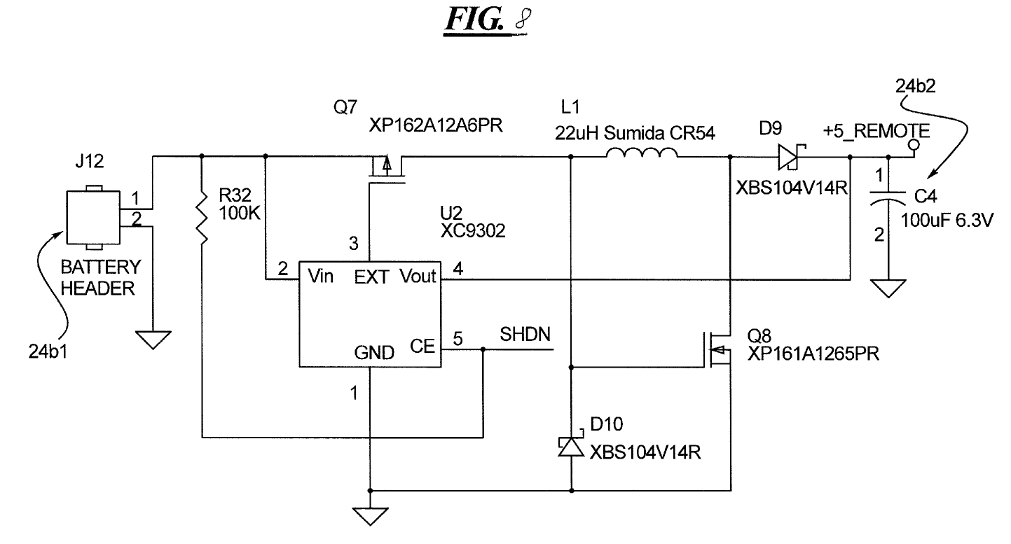

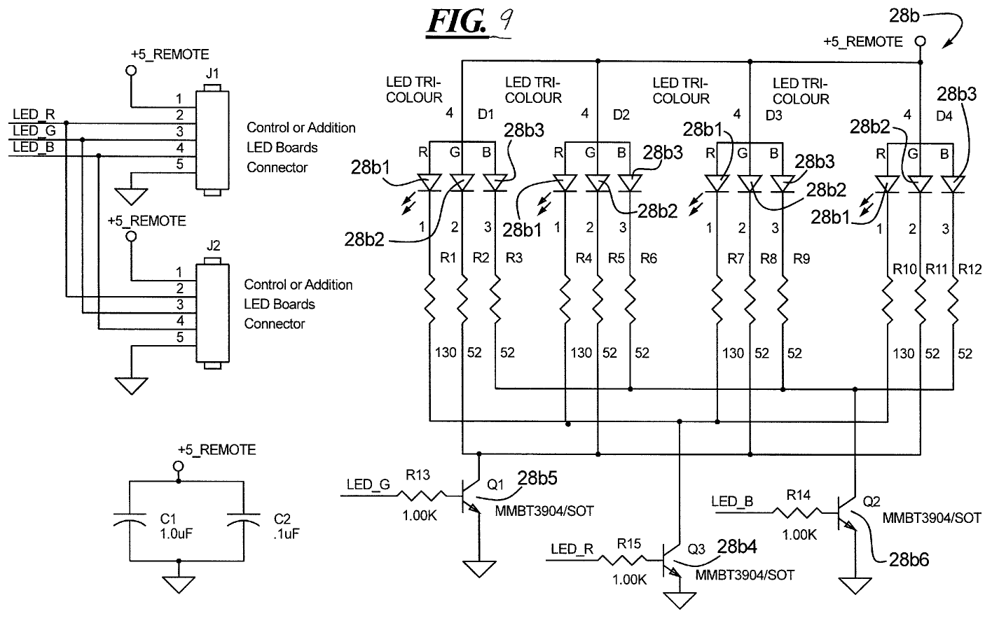

The schematic of FIG. 7 illustrates another exemplary user interface module 22b that may be used with an illumination and active emissions device, such as the device 10 of FIG. 1. Unlike the user interface modules 22, 22a of control units 20, 20a, the user interface 22b of FIG. 7 provides two tact switches 22b1, 22b2 wherein each switch 22b1, 22b2 may be electrically closed or opened based on the position of a key 18. The user interface module 22b may alternatively comprise slide switches, toggle switches, push buttons, or combinations thereof. The user interface module 22b may also provide fewer or more switches depending on the key 18 type. In the present embodiment, engaging the key 18, for example by pressing or rotating the key 18, may electrically open one or more of the switches 22b1, 22b2, transmitting a 5 VDC, or a logical high signal, to an input of a connected microprocessor 26. Accordingly, when the key 18 is not engaged by a user, switches 22b1, 22b2 may be electrically closed to transmit a 0 VDC, or a logical low signal, to an input of a connected microprocessor 26. The resulting action corresponding to the different combinations of input from the tact switches 22b1, 22b2 may be dependent on a predetermined sequence of operations stored within the microprocessor 26.

Turning to FIG. 8, a detailed view of a driver circuit 24b similar to the driver circuit 24 of FIG. 5 is provided. While many other configurations are possible, the driver circuit 24b of FIG. 8 serves as a buck-boost converter having an input 24b1 and an output 24b2. The driver circuit 24b may be configured to accept a wide range of DC input voltages, for example between 2 to 10 VDC, at the input 24b1 from a power source, for example, one or more batteries, or the like. The buck-boost converter serves to buck or boost the received input voltage to a predetermined DC output voltage, for example 5 VDC, at the output 24b2. The output 24b2 may provide the DC voltage required to power the rest of the control unit 20, for example the microprocessor 26, the white light source 27, the LED array 28, and the volatile active dispensers 30, 31, 32. If needed, the driver circuit 24b may also provide additional current for any connected auxiliary modules 33. Based on the application, the driver circuit 24b may alternatively take the form of a buck converter, a boost converter, or any other voltage converter.

Referring back to FIG. 5, the driver circuit 24 may provide power to the reference terminals of the microprocessor 26, for example, 5 VDC across pins 1 and 14. One or more tact switches may be coupled to the inputs of the microprocessor 26, for example via pins 2 and 10, to selectively enable the white light source 27, the LED array 28 and/or the volatile active dispensers 30, 31, 32 according to user input. Depending on the selected mode of operation, the microprocessor 26 may generate signals at output pins, for example pins 6-8, 9 and 11-13, corresponding to the volatile active dispensers 30, 31, 32, the white light source 27 and the LED array 28, respectively. Particularly, pulse width modulated (PWM) signals may be generated at the output pins according to a predetermined sequence of operations stored within the microprocessor 26.

As shown in FIG. 9, an exemplary LED array 28b may include a plurality of colored LEDs arranged in clusters of red, green and blue (RGB) LEDs 28b1-3. Power to the LED array 28b may be provided by a driver circuit 24, which is coupled in parallel to the LED array 28b. The microprocessor 26 may control one or more colors of the LED array 28b by selectively enabling a plurality of transistors 28b4-6. More specifically, the transistors 28b4-6 may turn on the LEDs 28b1-3 by enabling current to pass through the respective LEDs 28b1-3. For example, the first transistor 28b4 enables current to the red LEDs 28b1, the second transistor 28b5 enables current to the green LEDs 28b2, and the third transistor 28b6 enables current to the blue LEDs 28b3. Alternatively, the LED array 28b may comprise fewer or additional LEDs, and may also comprise LEDs of colors other than red, green or blue. The LED array 28b may also be extended to include a white LED and a corresponding transistor for providing illumination light. Furthermore, to evenly distribute and to optimize lighting effects, the LEDs 28b1-3 of the LED array 28b may be distributed radially in a satellite configuration, or the like.

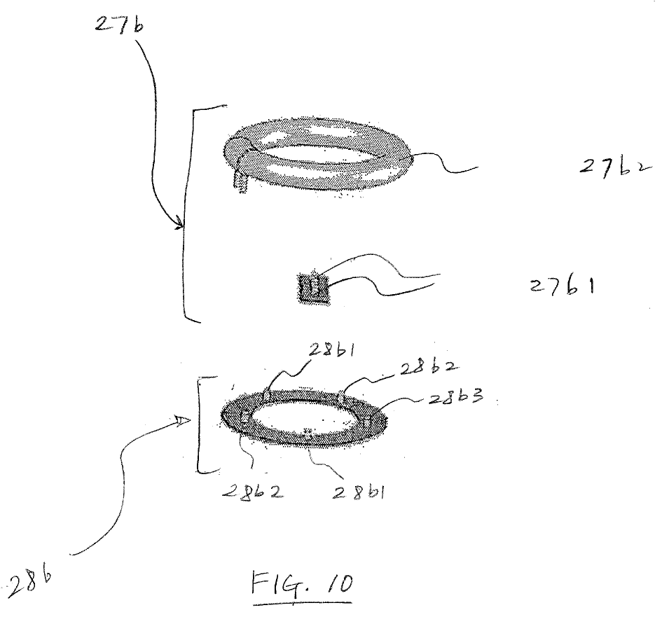

As shown in FIG. 10, one exemplary arrangement of white and colored light sources 27b, 28b that may be disposed within a base 14 of an illumination and active emissions device 10 is provided. The white light source 27b may include one or more white LEDs 27b1 and/or a compact fluorescent lamp (CFL) 27b2 disposed as a ring around the white LEDs 27b1. The colored light source 28b may provide colored LEDs 28b1-3 arranged in a satellite configuration, to evenly distribute colored light and to optimize lighting effects. Such a configuration may evenly distribute light from both a center portion and an outer portion of an illumination and active emissions device 10. Alternatively, the white light source 27b may include an organic light emitting diode (OLED), an ultraviolet light emitting diode (UV LED), an incandescent lamp, or combinations thereof. While power requirements for incandescent lamps and CFLs vary from those of LEDs, a driver circuit 24 may be modified to provide additional power, for example, AC power. Specifically, the driver circuit 24 may further receive additional power from an external plug-in adapter.

A predetermined sequence of multicolor light shows may be programmed onto the microprocessor 26. In an exemplary sequence, light shows from the white light source 27 and/or the LED array 28 may be enabled first by rotating the key 18 to an ON position. Subsequently, the microprocessor 26 may begin a first of a plurality of light shows and begin cycling through the different colors. Once the switch 19 associated with the key 18 has been pressed, the microprocessor may toggle to a subsequent light show. Similarly, consecutive presses of the switch 19 may toggle the microprocessor 26 through any remaining light shows. During any point in the sequence, pressing and holding the switch 19 may instruct the microprocessor 26 to pause and hold one color instead of cycling through light patterns. The microprocessor 26 may be programmed to hold a color until the switch 19 is pressed a second time. Rotating the key 18 into an OFF position may remove all power from the control unit 20. Alternatively, the sequence may further include selective control of a volatile active dispenser 30, 31, 32 to alter volatile active emission rates, selective control of any auxiliary modules 33 that may be connected, or the like.

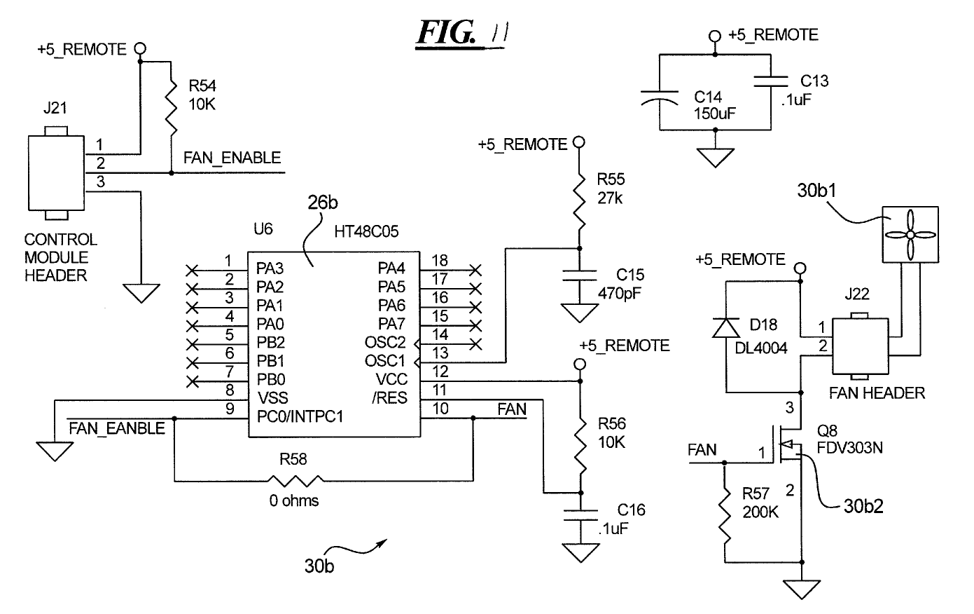

Turning to FIG. 11, an exemplary volatile active dispenser module 30b for a low output fan 30b1 to facilitate volatile active emissions from a passive delivery element is provided. More specifically, a connected microprocessor or microcontroller 26b may increase or decrease volatile active emission rates in response to user input. The volatile active dispenser 30b may be powered by the driver circuit 24 of FIG. 5 and controlled by an output of the microcontroller 26b, for example, pin 10. The microcontroller 26b may selectively enable the volatile active dispenser 30b by controlling current to the transistor 30b2. More specifically, an enabling signal from pin 10 of the microcontroller 26b may cause the transistor 30b2 to switch on, allow current to flow through the low output fan 30b1, and thus, increase the volatile active emission rate. Accordingly, a disabling signal from pin 10 of the microcontroller 26b may cause the transistor 30b2 to switch off, prevent current flow through the low output fan 30b1, and decrease the volatile active emission rate. Similarly, the volatile active dispenser 30b may be adapted to incorporate a high output fan, a heater element, a piezo atomizer, or combinations thereof. A high output fan may require additional power that may be supplied by an auxiliary power source or an adapter. A heater element may comprise a ceramic encased metal oxide heater powered by the driver circuit 24 or an additional power source. A piezo atomizer may comprise a control system which may also be powered by the driver circuit 24.

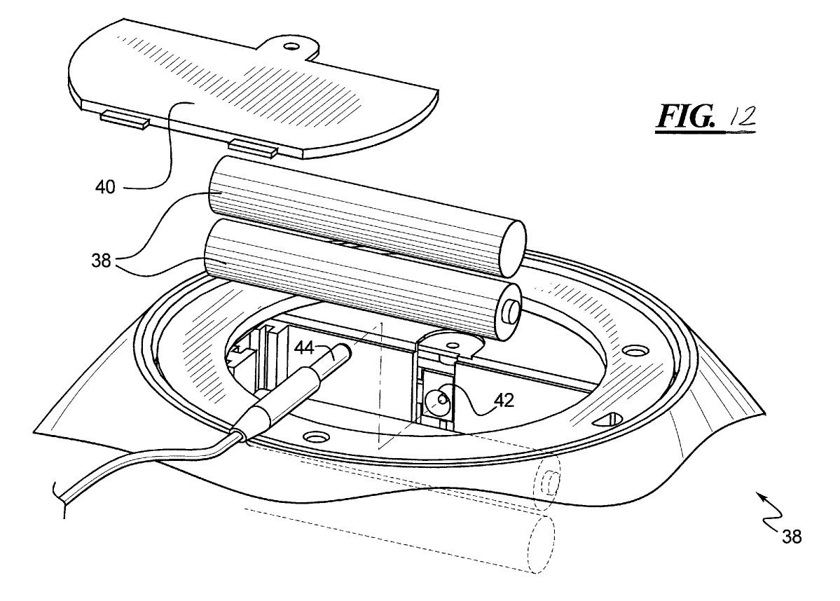

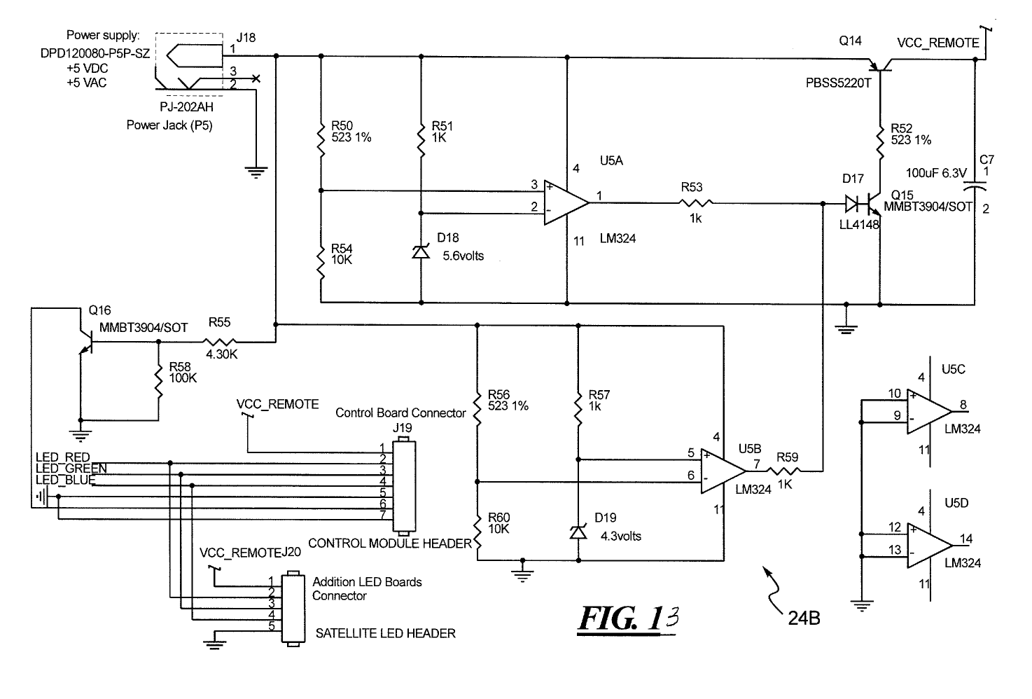

Referring now to FIG. 12, an exemplary battery compartment 36 for housing a DC power source is shown with batteries 38 and a compartment lid 40. The size and number of batteries 38 required may vary depending on the type of the driver circuit 24 employed and the amount of load connected to the driver circuit 24. As in the exemplary embodiment of FIG. 5, the driver circuit 24 may be configured as a buck-boost converter which converts any input voltage between 2 and 10 VDC to a 5 VDC output. Specifically, the compartment 36 may house, for example two to four AA alkaline batteries in series for providing 3 to 6 VDC, respectively. The battery compartment 36 may also include a hidden input jack 42 for receiving an adapter plug 44, which may be associated with, for example the power jack module 34b of FIG. 13. The power jack module 34b may be used to supply additional power to components that consume more power than the driver circuit 24 is capable of producing. In the exemplary schematic of FIG. 13, the power jack module 34b is configured to accept regulated 5 VDC, for example, from a plug-in class 2 power supply. Alternatively, the input jack 42 may be configured to receive more than just one type of plug 44, such that a wider range of adapters, in terms of physical size and voltage ratings, may be used. Aside from convenience, this also enables the device to be sold, and consumers to purchase the device, without the expense of a specially designed power adapter of its own. Moreover, the hidden input jack 42 may be disposed inside the battery compartment 36 to provide a more compact, clean and aesthetically pleasing design.

Based on the foregoing, it can be seen that the present disclosure provides devices with white light, colored light, volatile active emissions and no external switches. The modular design of the disclosure enables its application to a wide range of devices with similar features. The disclosed modules further promote the interchangeability and the expandability of modules and features associated with the disclosure.

While only certain embodiments have been set forth, alternatives and modifications will be apparent from the above description to those skilled in the art. These and other alternatives are considered equivalents and within the spirit and scope of this disclosure.

What is claimed:

1. An illumination source and volatile active emission dispenser, comprising:
a base comprising a modular control unit and a switch disposed on an interior of the base, the modular control unit comprising a driver circuit, a microprocessor, at least one white light source, a plurality of colored light emitting diodes (LEDs), and a volatile active dispenser;
a translucent element coupled to the base and configured to transmit light from at least one of the white light source and the colored LEDs; and
a volatile active cartridge disposed at least partially within the translucent element.

2. The illumination source and volatile active emission dispenser of claim 1, wherein the volatile active cartridge comprises a key to rotatably and pushably engage the switch.

3. The illumination source and volatile active emission dispenser of claim 2, wherein the key and the switch form a rectangular fitment.

4. The illumination source and volatile active emission dispenser of claim 2, wherein the key and the switch form a tri-lobe fitment.

5. The illumination source and volatile active emission dispenser of claim 1, wherein the modular control unit is expandable.

6. The illumination source and volatile active emission dispenser of claim 1, wherein the colored LEDs comprise red, green and blue LEDs.

7. The illumination source and volatile active emission dispenser of claim 1, wherein the colored LEDs are radially distributed in a satellite configuration.

8. The illumination source and volatile active emission dispenser of claim 1, wherein the modular control unit controls emission rates of the volatile active dispenser.

9. The illumination source and volatile active emission dispenser of claim 1, wherein the volatile active dispenser is a fan.

10. The illumination source and volatile active emission dispenser of claim 1, wherein the volatile active dispenser is a heater element.

11. The illumination source and volatile active emission dispenser of claim 1, wherein the volatile active dispenser is a piezo atomizer.

12. The illumination source and volatile active emission dispenser of claim 1, wherein the volatile active cartridge is configured to transmit light from at least one of the white light source and the colored LEDs.

13. The illumination source and volatile active emission dispenser of claim 1 further comprising a battery compartment on a bottom portion of the base, the battery compartment comprising a hidden input jack.

14. An illumination source and volatile active emission dispenser without external switches, comprising:
a base comprising a modular control unit and a switch disposed on an interior of the base, the modular control unit comprising a driver circuit, a microprocessor, at least one white light source, a plurality of colored LEDs, and a fan;
a battery compartment on a bottom surface of the base;
a translucent element coupled to the base configured to transmit light from at least one of the white light source and the colored LEDs; and
a volatile active cartridge disposed at least partially within the translucent element.

15. The illumination source and volatile active emission dispenser of claim 14, wherein the modular control unit comprises at least one white LED and a CFL.

16. The illumination source and volatile active emission dispenser of claim 14, wherein the colored LEDs comprise red, green and blue LEDs.

17. The illumination source and volatile active emission dispenser of claim 14, wherein the colored LEDs are radially distributed in a satellite configuration.

18. The illumination source and volatile active emission dispenser of claim 14, wherein the modular control unit controls emission rates of the volatile active dispenser.

19. An illumination source and volatile active emission dispenser, comprising:
a base comprising a modular control unit and a switch disposed on an interior of the base, the modular control unit comprising a driver circuit, a microprocessor, at least one white light source, a plurality of colored LEDs, and a volatile active dispenser, the white light source comprising one or more components selected from the group consisting of:
a white LED;
an organic light emitting diode (OLED);
an ultraviolet light emitting diode (UV LED);
an incandescent lamp; and
a compact fluorescent lamp (CFL);
a translucent element coupled to the base configured to transmit light from at least one of the white light source and the colored LEDs; and
a volatile active cartridge disposed at least partially within the translucent element.

20. An illumination source and volatile active emission dispenser without external switches comprising:
a base comprising a modular control unit and a switch disposed on an interior of the base, the modular control unit comprising a driver circuit, a microprocessor, at least one white light source, a plurality of colored LEDs, and a volatile active dispenser;
a translucent element coupled to the base; and
a volatile active cartridge at least partially disposed within the translucent element and comprising a key to mateably engage the switch, the switch capable of activating one or more functions selected from the group consisting of:
activating the sequence of light patterns;
turning on the white LED;
turning on the colored LEDs;
turning off the white LED;
turning off the colored LEDs;
scrolling through the light patterns;
holding a selected light pattern;
adjusting an intensity of the LEDs;
adjusting an output rate of the volatile active dispenser; and
deactivating the sequence of light patterns.
